(19) United States
(12) Patent Application Publication
(10) Pub. No.: US 2005/0053797 A1
(43) Pub. Date: Mar. 10, 2005

(54) Systems and methods for manufacturing, treating, and selling raw building materials

(76) Inventors: Scott W. Rumph, Sumter, SC (US); Randall H. White, Sumter, SC (US)

Correspondence Address: FINNEGAN, HENDERSON, FARABOW, GARRETT & DUNNER;LLP, 1300 I STREET, NW, WASHINGTON, DC, 20005, US

(21) Appl. No.: 10/875,963

(22) Filed: Jun. 25, 2004

Related U.S. Application Data
(60) Provisional application No. 60/482,776, filed on Jun. 27, 2003.

(51) Int. Cl. B05D 3/02

(52) U.S. Cl. 428/541; 427/558; 427/372.2

(57) ABSTRACT

A method and apparatus for applying a UV-curable, anti-fungal coating to raw building materials, and a business method for selling said coated raw building materials is described. The method may include supplying a volume of raw building materials to a conveyor system that conveys the raw building materials through a coating station wherein a UV-curable, anti-fungal coating is applied to the raw building materials. The conveyor system then conveys the coated raw building materials through a drying station, wherein a source of radiation, such as UV lamps, irradiate the raw building material to cure the coating. In addition to its anti-fungal properties, the coating, when dry, may mask cosmetic irregularities and provide a uniform appearance to the raw building materials, while allowing lumber grade stamps to remain visible.

### I. PRIORITY

The present application claims priority from U.S. Provisional Application No. 60/482,776 to Rumph, et al., filed Jul. 27, 2003, which is hereby incorporated herein by reference in its entirety.

### II. BACKGROUND OF THE INVENTION

A. Field of the Invention

The present invention is generally directed toward coatings applied to raw building materials. More particularly, the present invention is related to, for example, UV-cured or EB-cured antifungal coatings applied to raw building materials, their composition, and methods of application. Further, the present invention may also encompass methods of selling and/or marketing pre-coated raw building materials, particularly including materials coated with a UV-cured or EB-cured antifungal coating.

B. Description of Related Art

A growing concern in the building industry today is that of mold growth upon building materials. Particularly in a relatively warm and humid environment, unchecked mold infestation can severely and irreversibly damage the structural integrity of building materials. Further, mold infestation may present a health risk to occupants of infested buildings.

Raw building materials may be treated with a chemical composition prior to sale to a consumer. For example, raw building materials such as framing lumber may be pressure-treated with a water-based pesticide, chromated copper arsenate (“CCA”), to protect the wood from mold and insects, especially in outdoor applications, such as decking. The use of CCA as a lumber treatment for residential purposes was phased out pursuant to a voluntary agreement between the Environmental Protection Agency and the lumber industry, due to concerns about the leeching of arsenic from treated lumber. Similar water-based pesticides have since been used as an alternative to CCA. These alternatives include Ammoniacal Copper Quat (ACQ) and Copper Boron Azole (CBQ). While these alternative treatments lack arsenic, they are water-soluble and thereby present manufacturing problems. Water-soluble treatments require considerable drying time and require considerable resources (i.e., water). Further, the environmental impact of using water or other solvents for coating raw building products is considerable. Using a substantially solventless composition, such as a UV-curable composition, for providing raw building materials with an anti-fungal coating may alleviate these manufacturing and environmental concerns.

### III. SUMMARY OF A FEW ASPECTS OF THE INVENTION

Consistent with an aspect of the present invention, raw lumber and other building materials are coated to inhibit, prevent, or impede fungal growth. Typically, UV-curable antifungal coatings may be applied to raw building materials in bulk at the point of production or at a point in the supply chain prior to delivery to or use by an end user. The present invention may also include methods and apparatus for applying the coatings to raw building materials as they are produced or before distribution to or use by an end user. This may be accomplished for, example, by locating a bulk coating machine at a point of lumber production or at some intermediate point in the supply chain. Alternatively, a coating apparatus may be located at a construction job site, (e.g., in a mobile unit), to facilitate pre-coating of raw building materials.

Another aspect of the present invention may relate to a method of selling or marketing raw building materials that have been pre-treated with any sort of composition. More particularly, the present invention may relate to a method of selling or marketing raw building materials that have been pre-treated with paint and/or an antifungal composition. Similarly, the present invention may also include a method of supplying a lumber reseller or distributor with raw building materials that have been pre-treated with a coating, including paint and/or an antifungal coating. The present invention may also include advertising or offering for sale raw building materials such as lumber, that have been pre-treated with a paint and/or an antifungal coating. In addition to advertising its antifungal qualities, the present invention may also include any advertising in connection with raw building materials that have been pre-treated to at least partially cover cosmetic blemishes.

The present invention may also involve the chemical composition of specific coatings as described herein. Further, the invention may involve the use of high speed coating and curing equipment, for raw building materials.

The foregoing was a brief summary of only a few aspects of the invention, and is not to be interpreted as limiting the intended scope of the claimed invention.

### IV. BRIEF DESCRIPTION OF THE DRAWINGS

FIG. 1 illustrates an exemplary system for coating raw building materials, in accordance with the invention;

FIGS. 2A-2E illustrate different exemplary configurations for supplying raw building materials to the conveyor system within the supply chain, in accordance with the invention;

FIGS. 3A-3D illustrate exemplary components of embodiments of a conveyor belt system for conveying raw building materials, in accordance with the invention;

FIGS. 4A-4B illustrate exemplary components of embodiments of a roller system for conveying raw building materials, in accordance with the invention;

FIGS. 5A-5B illustrate exemplary components of embodiments of coating system in general, and a vacuum coater, in particular, in accordance with the invention;

FIG. 6 is a table showing degrees of fungal growth after application of a coating in accordance with the present invention;

FIG. 7 illustrates an exemplary lumber grade stamp that may be translucently coated in accordance with the invention;

FIG. 8 illustrates exemplary components of drying system for irradiating raw building materials, in accordance with the invention;

FIG. 9 illustrates exemplary components of a combination coating/drying chamber, in accordance with the invention;

FIG. 10 illustrates a flowchart of an exemplary a method of manufacturing and selling raw building materials coated in accordance with the invention;

FIG. 11 illustrates several exemplary methods for selling or marketing raw building materials that are pre-coated with a coating (e.g., a UV-curable anti-fungal coating) in accordance with the invention.

### V. DESCRIPTION OF PREFERRED EMBODIMENT

Reference will now be made in detail to the present exemplary embodiments of the invention, examples of which are illustrated in the accompanying drawings. Wherever possible, the same reference numbers will be used throughout the drawings to refer to the same or like parts.

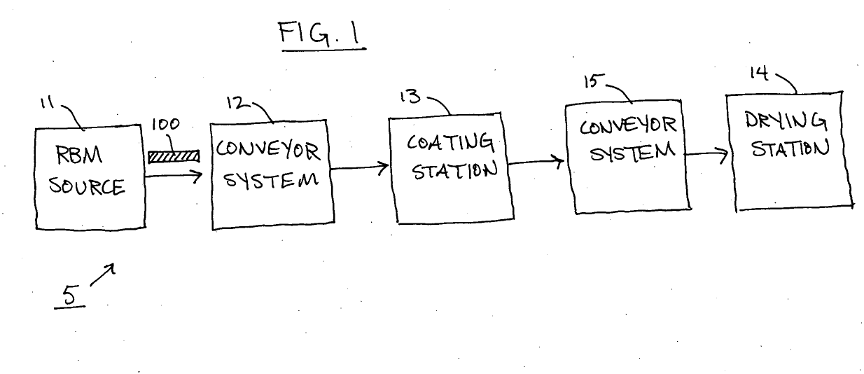

FIG. 1 illustrates a system 5 for coating raw building materials (“RBM”). System 5 includes an RBM source 11 from which RBM 100 can be supplied to a first conveyor system 12. RBM source 11 may include, for example, a lumber mill, warehouse, mobile vehicle, or other mechanism for delivering RBM to, for example, a conveyor system. Raw building materials may refer to at least one of wood framing lumber, plywood sheeting, chipboard sheeting, sheet rock, particle board, soffet board, cementious board, wood trim lumber, facia board, and composite board, prefabricated roof trusses, and/or any other unfinished material of building construction. Framing lumber may include dimensional lumber of a number of nominal cross-sections, including at least 2×2, 2×3, 2×4, 2×6, 2×8, 2×10, 2×12, 4×4, 4×6, 4×10, and 6×6. Framing lumber may further include finish lumber of a number of nominal cross-sections, including 1×4, 1×6, 1×8, 1×10, and 1×12. Framing lumber may further include glue-laminate of a number of nominal cross-sections, including 4×10, 4×12, 6×10, and 6×12. Glue-laminate may be comprised of a plurality of units of dimensional lumber permanently affixed to one another thereby effectively creating a larger beam. Framing lumber may further include micro-laminate of a number of nominal cross-sections, including 4×12. Micro-laminate may comprise a plurality of layers of sheets of wood, each subsequent layer of wood having its grain oriented in a direction substantially perpendicular to the previous layer. Framing lumber may also include tongue-and-groove and shiplap, both of a number of nominal cross-sections, including 1×4, 1×6, and 1×8. Other types and nominal cross-sections of framing lumber will be apparent to one skilled in the art.

Returning to FIG. 1, RBM 100 is next passed by conveyor system 12 to coating station 13, which may typically coat RBM 100 with an anti-fungal, UV curable coating. A second conveyor system 15 (which may be a part of conveyor system 12 or which may be its own independent system) may receive RBM 100 from coating station 13 and supplies RBM 100 to a drying station 14, which cures and dries the coating.

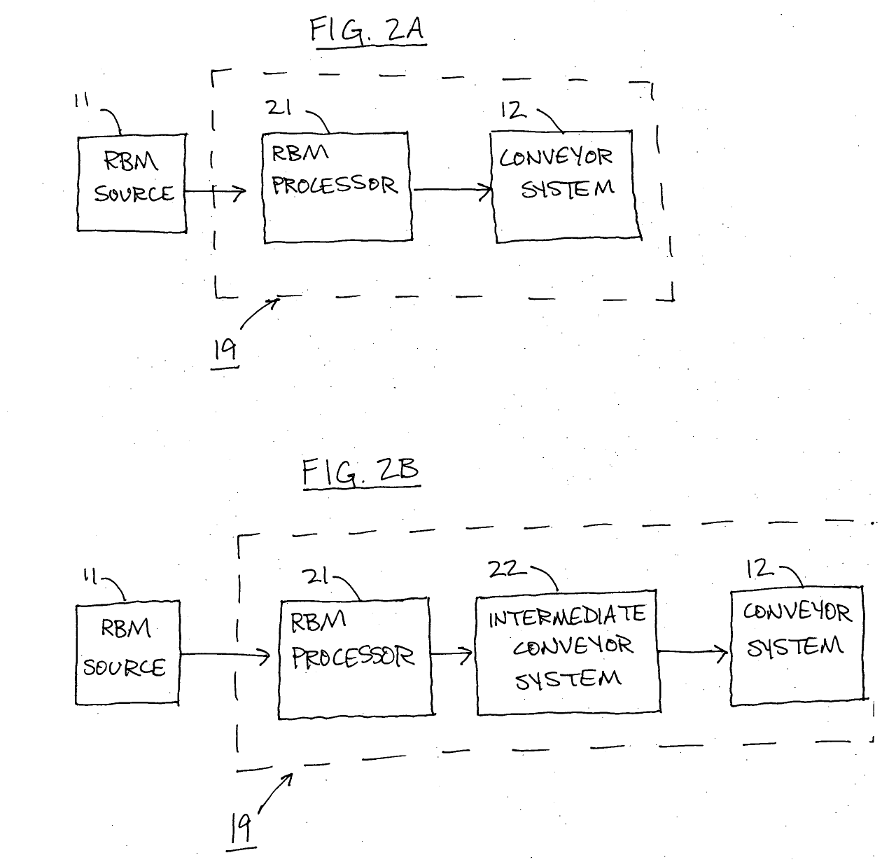

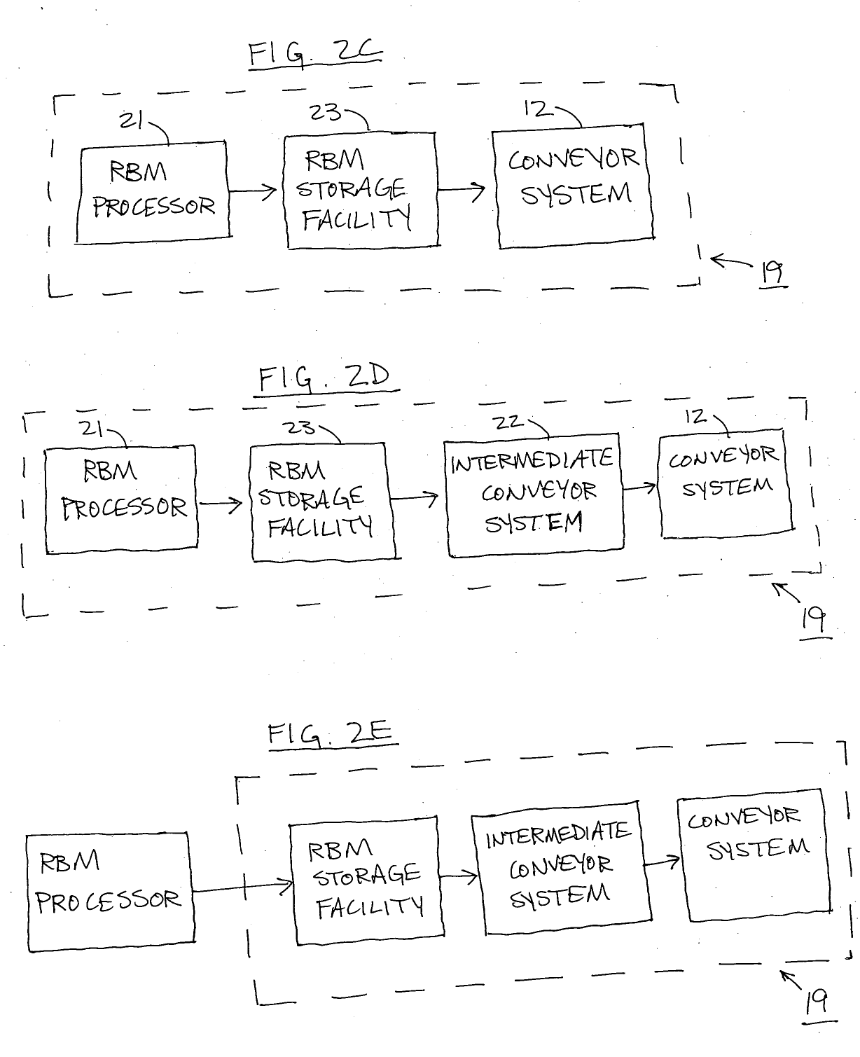

As shown in FIG. 2A, an RBM processor 21 may optionally be provided for processing RBM 100 received from source 11. Processor 21 may include conventional equipment configured to process RBM 100. For example, processor 21 may be configured to perform one or more of the following on RBM 100: planing, sanding, lathing, ripping, cross-cutting, mitering, drilling, routing, or otherwise shaping the raw building material. Once the process is complete, the output RBM may be directly supplied to conveyor system 12, in which case, conveyor system 12 may constitute part of RBM processor 21.

Consistent with an alternative aspect of the present invention, RBM may be transferred to conveyor system 12 by an intermediate system 22, as illustrated in FIG. 2B. For example, the intermediate system 22 may include manual transfer of RBM 100 to conveyor system 12. In addition, other conventional conveyance systems may be used, such as a forklift that collects the output of processor 21 on a pallet and transfers the pallet with RBM 100 disposed thereon to conveyor system 12. Another type of intermediate system 22 may involve an automated conveyance system comprising, for example, conveyors such as those described with respect to the conveyor system 12.

As shown in FIG. 2C, RBM 100 may be supplied to the conveyor system 12 after temporary storage in storage facility 23. The storage facility 23 may be located at a site 19 that comprises both the raw building material processor 21 and the conveyor system 12. In this case, at least a portion of the output of the raw building material processor 21 may be transferred to the raw building material storage facility 23 where it is stored before at least a portion thereof is transferred to conveyor system 12. During the period of time that RBM 100 is stored in storage facility 23, RBM 100 may be subjected to a desired temperature or humidity or other environmental conditions to treat RBM 100 for further processing. When such treatment of at least a portion of RBM 100 is completed, that portion of RBM 100 may be transferred from storage facility 23 to conveyor system 12. As with the output of raw building material processor 21, the output storage facility 23 and conveyor system 12 may be one and the same. Alternately, as shown in FIG. 2D, an intermediate conveyance system 22 may be used to transfer the output of storage facility 23 to conveyor system 12. As discussed above, this intermediate conveyance system 22 may include a conventional manual, mechanical (e.g., by pallet and forklift), or an automated conveyance system.

Further, as shown in FIG. 2E, storage facility 23 may be located at a site 25 that comprises the conveyor system 12, but not the raw building material processor 21. For example, RBM 100 may be transported to storage facility 23 from, for example, an off-site raw building material process facility 21 or from a raw building material distributor. RBM 100 may be accumulated at storage facility 23 before at least a portion thereof is transferred to conveyor system 12. RBM 100 may be transferred to conveyor system 12 by a conventional intermediate conveyance system as discussed above.

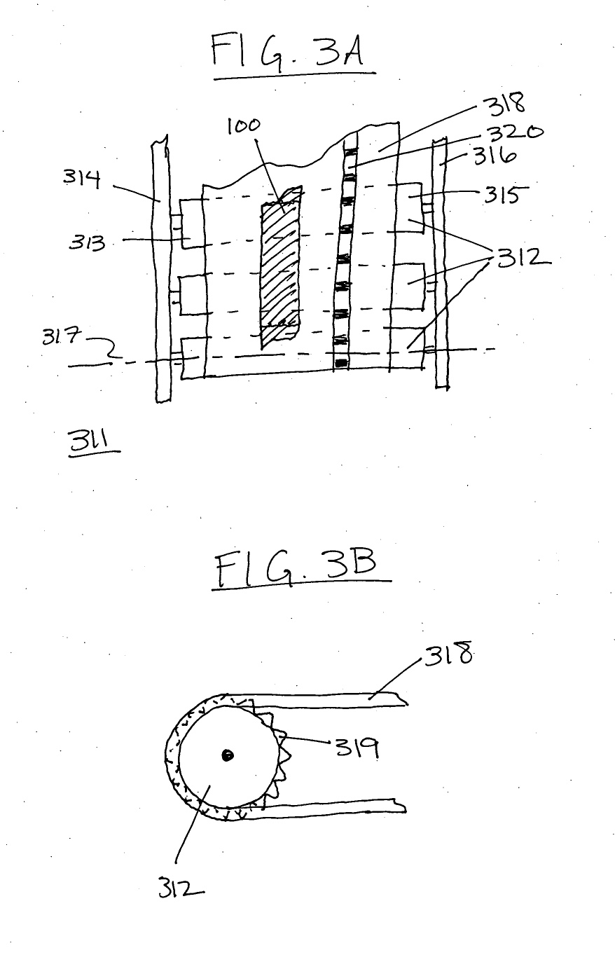

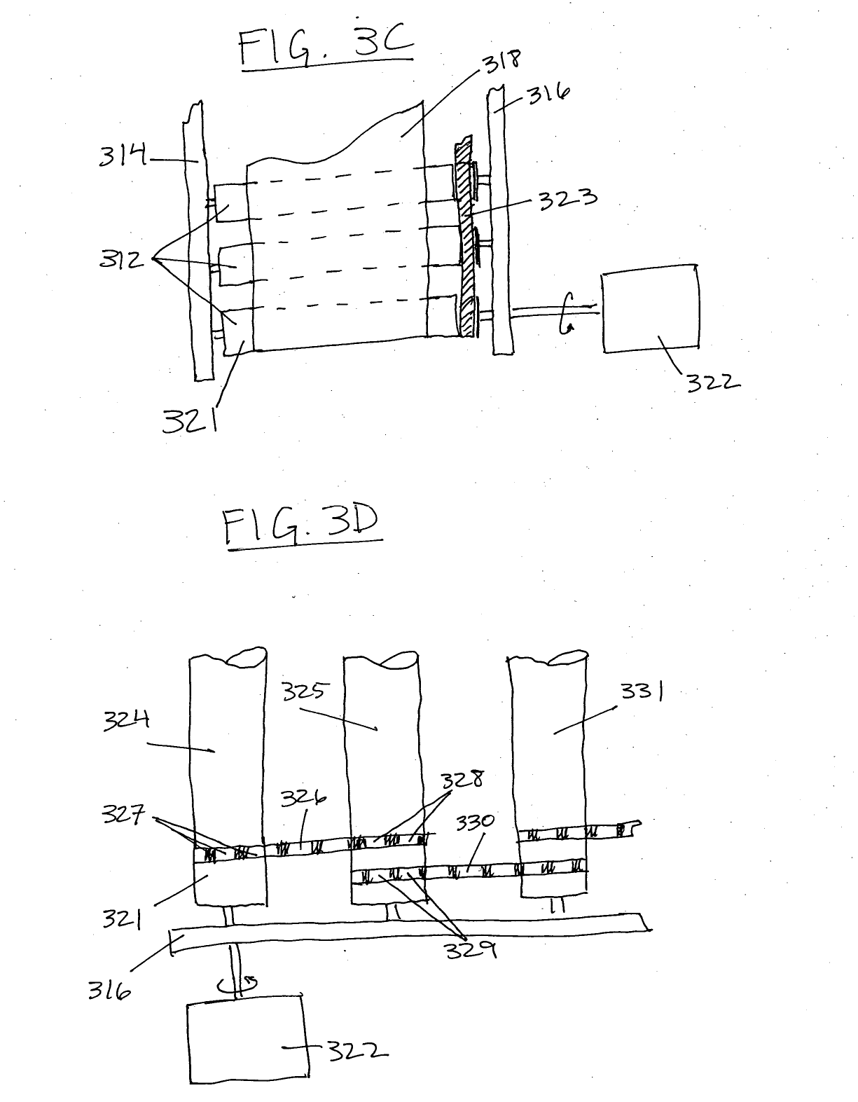

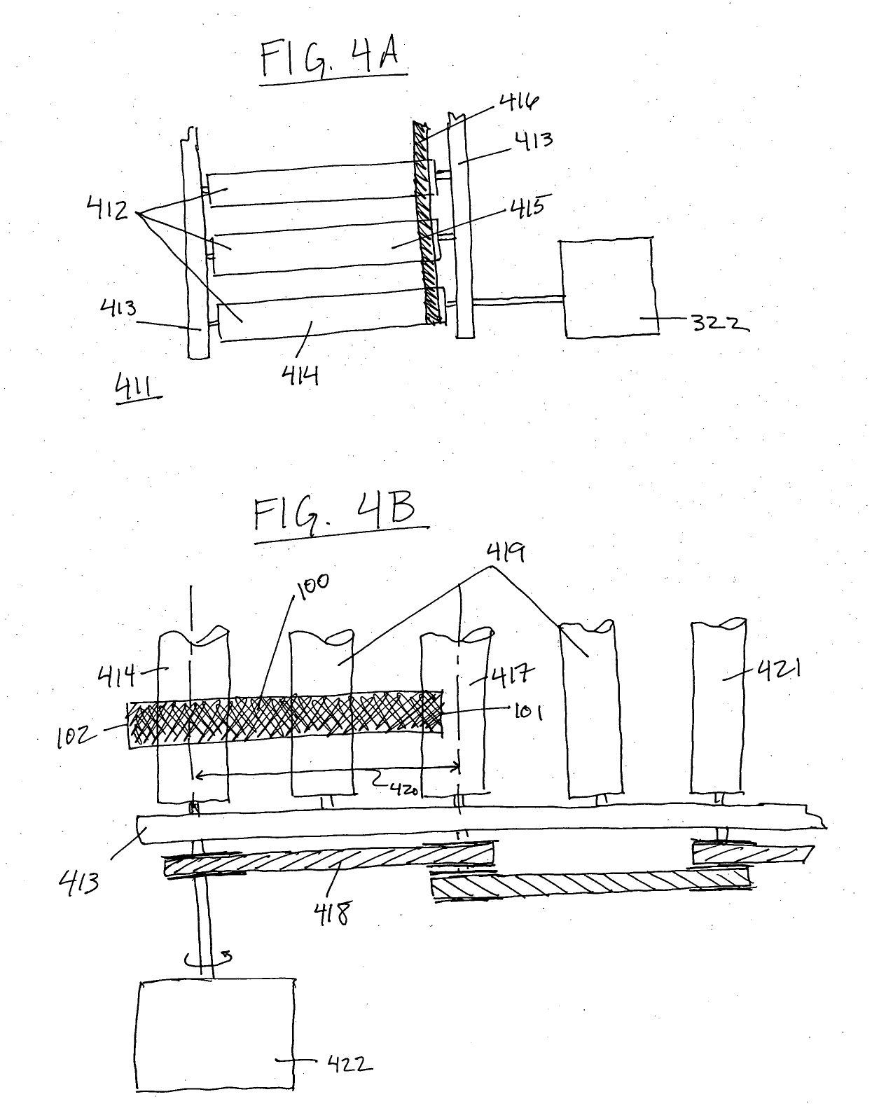

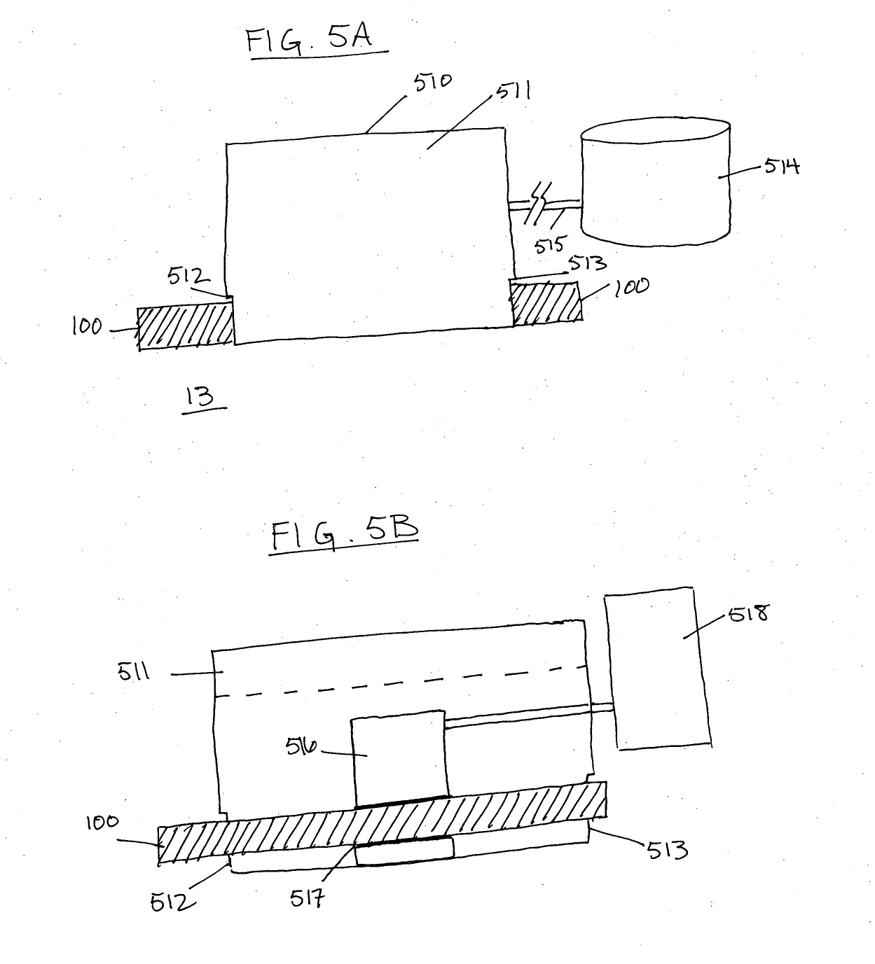

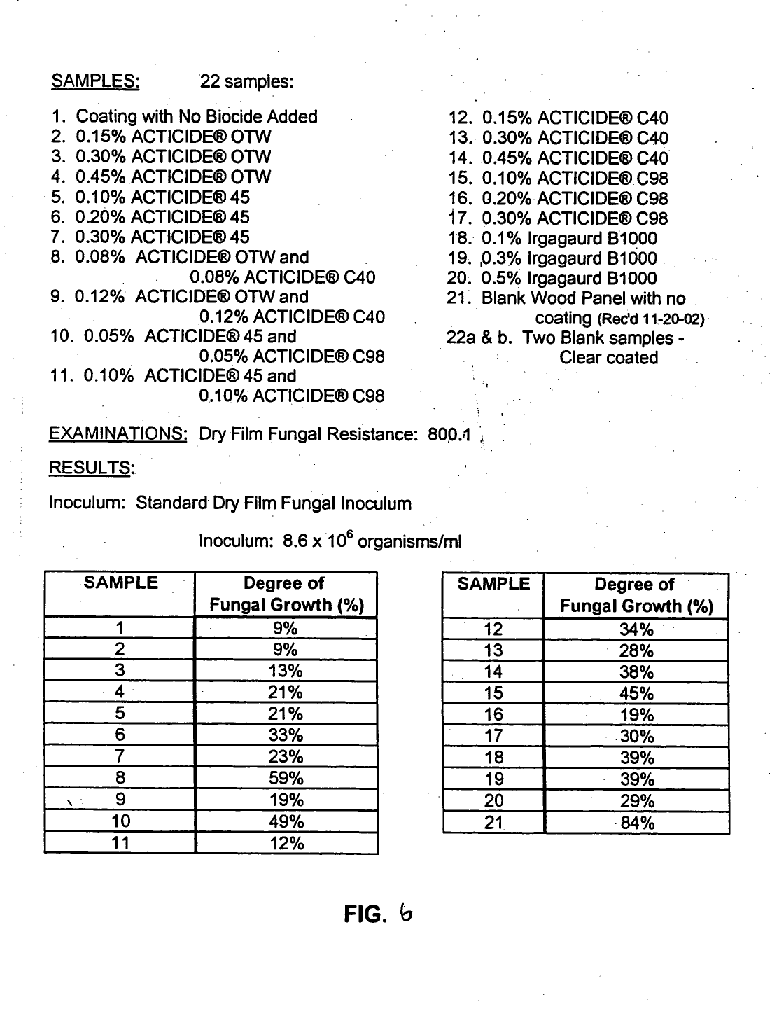

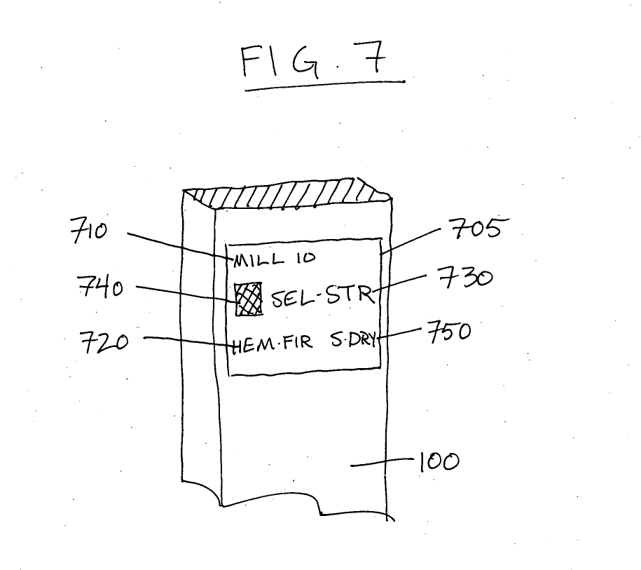

In accordance a further aspect of the present invention, a method and apparatus for inhibiting fungal growth on RBM will be described with reference to FIGS. 3A-4B, which illustrate examples of conveyor system 12 in greater detail.

One or more conveyor systems may be used in connection with the invention. At the outset, it should be noted that many different types of conveyor systems are well known in the art, the invention, in its broadest sense, is not limited to any particular conveyor systems. However, for exemplary purposes only, FIGS. 3-4 provide a few examples.

As shown in FIG. 3A, conveyor system 12 can include a conveyor belt system 311 or a series of multiple conveyor belt systems. A conveyor belt system 311 may include a plurality of substantially parallel rollers 312. A first end 313 of each roller may be mounted to a first frame 314, and a second end 315 of each roller may be mounted to a second frame 316. Each end 313, 315 of each roller 312 may be mounted to each frame 314, 315 in such a way to allow the roller 312 to rotate. Further, the longitudinal axis 317 of each roller 312 may be substantially perpendicular to the direction traveled by RBM 100 as it is conveyed by the conveyor system 12. An endless belt 318 may be wound about the plurality of rollers 312 and maintained at a tension sufficient to minimize slippage between the belt 318 and the rollers 312 while conveying RBM 100.

As shown in FIG. 3B, slippage may optionally be minimized by providing at least one roller 312 with a row of teeth or protuberances 319 about its circumference. Teeth 319 mesh with a corresponding row of slots 320 in belt 318. In addition to minimizing slippage, the intermeshing teeth 319 and slots 320 may transfer the angular motion of rollers 312 to the generally linear motion of belt 318.

As shown in FIG. 3C, at least one of the plurality of rollers 312 may be a driven roller 312 connected, either directly, as by a shaft, or indirectly, as by a series of gears, belts, and/or chains, to a power source, such as motor 322. Motor 322 may provide power sufficient to convey, through the rotation of rollers 312, RBM 100 towards coating station 13. The power applied to driven roller 321 by motor 322 may be delivered to the other rollers through a number of means. For example, the power may be delivered through the belt tension. Power may be transferred alternatively by a drive belt 323, such as a flat belt or a V-belt, or by a chain connecting a plurality of rollers.

As a further example, a plurality of belts or chains connecting a plurality of rollers may deliver power to rollers 312. In the example shown in FIG. 3D, a first roller 324 may be connected to a second, adjacent roller 325 by a first chain 326. As the first roller 324 rotates, teeth or protuberances 327 about its circumference mesh with first chain 326, imparting motion that may be transferred to the second, adjacent roller 325 through a first row of teeth or protuberances 328 about its circumference. As the second, adjacent roller 325 rotates, a second row of teeth or protuberances 329 about its circumference mesh with a second chain 330, imparting motion that may be transferred to a third roller 331, adjacent to second roller 325. Thus, for a conveyor belt with N rollers (1 through N) and (N−1) connecting chains (1 through (N−1)), each roller x (except roller 1 and roller N) may be connected to roller (x−1) by chain (x−1), and to roller (x+1) by chain x. Further examples and features of a conveyor belt would be apparent to one skilled in the art.

FIG. 4A illustrates a series of rollers consistent with a further aspect of the present invention. As explained in connection with conveyor belt system 311, each end of each of a plurality of rollers 412 may be mounted on a frame 413 in such a way as to allow each roller 412 to rotate. At least one of the plurality of rollers 412 may be a driven roller 414 connected to a power source, such as a motor 422, either directly as by a shaft, or indirectly, as by a series of gears, belts, and/or chains. The surface of the at least one driven roller 414 may be textured or coated with a material such as rubber so as to increase the coefficient of friction between the surface of driven roller 414 and RBM 100 to an extent sufficient to prevent slippage between driven roller 414 and RBM 100 when power is applied to driven roller 414. When power is thus applied to the driven roller 414, it will advance RBM 100 across adjacent rollers 415. As described in connection with conveyor belt system 311, the driven roller 414 may deliver power to adjacent rollers 415 through belts or chains 416. The surface of adjacent rollers 415 to which power is transferred may also be textured or otherwise coated with a material such as rubber to increase the coefficient of friction between adjacent rollers 415 and RBM 100.

Alternately, as shown in FIG. 4B, driven roller 414 may deliver power to at least one non-adjacent roller 417, 421. The driven roller 414 may transfer power to a first non-adjacent roller 417 using a belt or chain. At least one passive roller 419 may be positioned between the driven roller 414 and the first non-adjacent roller 417. A passive roller 419 freely rotates and is not driven by a power source. As driven roller 414 advances RBM 100 across the conveyor system, passive rollers 419 may rotate as RBM 100 passes across the surface of the passive rollers 419. Driven roller 414 and first non-adjacent roller 417 may be separated by a distance less than the length of RBM 100. That is, the distal end 101 of a unit of RBM 100 should reach first non-adjacent roller 417 at least before the proximal end 102 of the unit of RBM 100 passes beyond driven roller 414. Preferably, conveyor system 12 may be configured to convey RBM 100 in lengths of at least about eight feet. Thus, driven roller 414 and first non-adjacent roller 417 may be separated by a distance less than about eight feet. First non-adjacent roller 417 may transfer power to at least a second non-adjacent roller 421, and at least one passive roller 419 may be positioned between the first and second non-adjacent rollers 417, 421. The first and second non-adjacent rollers 417, 421 may be configured to convey RBM 100 in lengths of at least eight feet.

As embodied herein, the conveyor system may include, for example, at least one of a conveyor belt, rollers, nip rollers, and/or any other conveyor system that is well-known in the art. The conveyor system may be configured in such a way to convey at least one of RBM 100 described above. Further, the conveyor system may be configured to convey raw building material at a rate of at least about 50 feet per minute (fpm), and preferably at about 100 fpm. The conveyor system may be further configured to convey raw building materials at a rate of up to about 500-600 fpm. Additionally, the conveyor system may be further configured to convey raw building materials at a rate of about 50-200 fpm, about 200-350 fpm, and/or about 350-600 fpm.

Coating station 13 will next be described in greater detail with reference to exemplary FIGS. 5A and 5B. Coating station 13 comprises a structure 510 wherein a volume of coating is applied to the surface of RBM 100. The coating may be applied to RBM 100 substrate by a number of methods, including, but not limited to vacuum coat, brush, spray coat, curtain coat, dip and squeegee, and roller coat. Conveyor system 12 may advance RBM 100 through structure 510. The structure 510 may be substantially enclosed, and may include a chamber 511. Chamber 511 may include at least a first opening 512 and second opening 513, such that RBM 100 enters chamber 511 through first opening 512 and exits chamber 511 through second opening 513 after the coating is applied. A reservoir 514 may supply the coating to coating station 13. The reservoir 514 may be affixed to coating station 13, or may be located apart from coating station 13 to supply the coating to chamber 511 through a pipe, hose 515, other conduit.

A preferred coating method may include a so-called “vacuum coating” method, whereby a vacuum coater 516 is permanently located in a factory or other manufacturing facility or location in the RBM supply chain. In such a system, RBM 100 may be fed through first opening 512 into coating chamber 511, where it passes through a coating in an atmosphere. Negative pressure in chamber 511 may pull the surrounding air, at controlled speed, through a small fissure 517 around RBM 100 and draw excess coating back into a separation tower 518. The coating may then continuously recycle back into chamber 511. Alternatively, a vacuum coater 516 may be placed in mobile equipment, allowing the coating to be applied at construction sites or processing facilities as needed, or within a manufacturing facility where mobility is desired. The vacuum coater method allows control of coating thickness, preferably between 0.2 and 0.5 mils, although greater or lesser thicknesses are contemplated within the scope of the invention, depending upon the composition of the coating and preferences regarding finished appearance. The vacuum coat method is also efficient in terms of product conservation, as unused coating may be recycled through the system. As a result, up to about 99% of the coating may be applied to RBM 100. In this example, the coating may applied efficiently, with waste and contamination to the surrounding atmosphere minimized. A commercially-available vacuum coater, consistent with an embodiment of the invention, is manufactured by Delle Vedove, of Charlotte, N.C.

Consistent with an additional aspect of the invention, a chemical composition may be provided, that can be applied to raw building materials in order to impede fungal growth. The composition may be cured, or substantially dried, by irradiation. Curing by irradiation, as used herein, involves a source of radiation such as ultraviolet light or electron beams providing electromagnetic energy to effect a chemical and physical change in the organic coating, such as to form a crosslinked polymer network. The composition may comprise the following: at least one oligomer for film formation, at least one monomer for film formation, at least one photoinitiator/photosensitizer to initiate free radical polymerization, and at least one pigment for imparting at least color, gloss control, phixotropic qualities, and/or structural integrity. The composition may additionally comprise other additives, including biocides which aid in preventing fungal growth. In an exemplary formulation consistent with the present invention, oligomers may account for approximately 30-40% of the composition by weight, monomers 40-60%, photoinitiators/photosensitizer 5-10%, pigments 15-20%, and other additives 0-2%.

Oligomers are base resins or polymers that may be used to form the film in radiation cured coatings. These may be macromolecules including a number of monomer units which may impart properties such as adhesion, flexibility, hardness, moisture resistance, weatherability, etc. to the coating. The oligomer may be substantially 100% reactive, substantially solventless, difunctional acrylates of bisphenol A liquid epoxy resins which may be cured by irradiation. In UV curing, ultraviolet light may be absorbed by a photosensitized film, while in EB curing, electrons are passed through the film or coating. Both processes may initiate free radical polymerization, which may produce rapid and immediate cure. Non-exhaustive examples of commercially-available oligomers that may be used in the composition may include: Ebecryl® 3500 and Ebecryl® 3720, both acrylated epoxies commercially available from UCB Chemicals of Smyrna, Ga.; and InChemRez UV-91TP20, an epoxy acrylate available from InChem Corp. of Rock Hill, S.C. These particular oligomers are exemplary only, and one skilled in the art would recognize suitable substitutes according to stated functionality and chemical compatibility.

Monomers may provide unique benefits for the radiation-cured coating. These relatively low weight molecules may be up to substantially 100% reactive and may serve to dilute the viscosity of the high molecular weight oligomers with which they are blended in the composition. In addition to viscosity control, monomers may contribute to and modify the performance properties of the cured film. The monomers may be diluents, and may be monofunctional or multifunctional, and may affect the crosslink densities of the coating composition. Non-exhaustive examples of commercially-available monomers include: HDODA and TRPGDA, acrylated polyols available from UCB Chemicals; Photomer® 4061-Mod., a tripropylene glycol diacrylate available from Henkel Corporation of Ambler, Pa.; and V-Pyrol®/RC, a vinylpyrrolidone, and V-Cap™/RC, a vinylcaprolactam, both available from International Specialty Products of Wayne, N.J. These particular monomers are exemplary only, and one skilled in the art would recognize suitable substitutes according to stated functionality and chemical compatibility.

Photoinitiators are typically molecules that form a reactive species which starts a chain reaction, thereby effecting polymerization when exposed to a specific wavelength of energy in the form of UV radiation, for example. Photosensitizers are molecules that may transfer their energy and form the free radicals necessary to initiate the polymerization when they interact with certain other chemicals. These initiators may absorb light energy in various wavelengths and power, and then transfer that energy in useful quantities to effect rapid polymerization. These chemicals may function via various donor/acceptor pathways and represent a variety of different chemistries. Some are added as dry powders and often dissolved, while others are already in liquid form. Non-exhaustive examples of commercially-available photoinitiators/photosensitizers include: Acetocure 73, a 2-hydroxy-2-methyl-propiophenone available from Aceto Corporation of Lake Success, N.Y.; Irgacure® 184, a 1-hydroxy-cyclohexyl-phenyl-ketone available from Ciba Specialty Chemicals of Basel, Switzerland; PI-718, a 2,4,6-trimethybenzoyl-diphenylphosphine oxide available from Procachem Corporation. These particular photoinitiators/photosensitizers are exemplary only, and one skilled in the art would recognize suitable substitutes according to stated functionality and chemical compatibility.

Pigments may be also be added to the coating composition for a number of different functions. Primary pigments may be added to give a coating the characteristic color of the finished product. Different primary pigments may be incorporated into the coating to created a variety of different colors. A pigment may be used to provide the finished good with an indicator of its source of origin, for example. For example, a lumber mill or lumber reseller might choose to coat volumes of lumber in the same color to indicate the source. To this end, advertising associated with the color may be provided consistent with a further aspect of the present invention. Such primary pigments include, for example, the commercially-available pigment dispersions manufactured by Penn Color of Doylestown, Pa. These particular primary pigments are exemplary only, and one skilled in the art would recognize suitable substitutes according to stated functionality and chemical compatibility.

Extender pigments are versatile pigments that by design can fill a variety of applications. Fillers can serve to modify the rheology of complex liquid systems both in the can and when applied, and can contribute to the coating strength and flexibility. Extender pigments can impart hydrophobicity, enhance the exterior durability, inhibit mold growth, and/or control the gloss of the coating. Non-exhaustive examples of commercially-available pigments include Aerosil®, a highly dispersed or fumed silicon dioxide for available from Degussa Corporation of Parsippany, N.J., used for its phixotropic qualities to inhibit settling of the pigments; Nicron® 353, a high purity, platy, microcrystalline talc available from LuzenacAmerica of Englewood, Colo.; Pioneer 4319, a platy Texas talc available from Zemex Industrial Minerals of Atlanta, Ga., used for gloss control and to impart structural integrity; and Syloid®, synthetic amorphous silicas surface-treated with hydrocarbon-type wax, available from Grace Davison of Columbia, Md., used for gloss control; and Eagle Zinc No. 417, a pigment grade zinc oxide, available from Eagle Zinc Company of New York, N.Y., used to inhibit mold growth. These particular pigments are exemplary only, and one skilled in the art would recognize suitable substitutes according to stated functionality and chemical compatibility.

Additives incorporated in the coating may serve multiple purposes. Some of these may function as adhesion promoters, inhibitors, pigment dispersers, stabilizers, flow and level controllers, surface tension modifiers, foam control, and bacteriological control. Non-exhaustive examples of particular chemicals successfully tested for bacteriological control include 5-chloro-2-(2-4-dichlorophenoxy)phenol, 2-n-octyl-4-isothiazolin-3-one, and tetracholoisophthalonitrile. These particular additives are exemplary only, and one skilled in the art would recognize suitable substitutes according to stated functionality and chemical compatibility.

A first exemplary formulation for a UV-curable coating for raw building materials may be prepared using the components discussed above, according to the following approximate weight ratios.

| Component | Trade Name | Wt. % |
|---|---|---|
| Oligomer | Ebecryl ® 3500 | 33.6 |
| Monomer | HDODA | 37.5 |
| Monomer | V-Pyrol ®/RC | 4.9 |
| Photoinitiator/Photosensitizer | Acetocure 73 | 1.9 |
| Photoinitiator/Photosensitizer | Irgacure ® 184 | 3.0 |
| Photoinitiator/Photosensitizer | PI-718 | 0.5 |
| Extender Pigment | Aerosil ® | 2.0 |
| Extender Pigment | Syloid ® | 5.9 |
| Extender Pigment | Pioneer 4319 | 9.9 |
| Primary Pigment | Penn Color | 0.7 |

A second exemplary formulation for a UV-curable coating for raw building materials may be prepared with the components discussed above according to the following approximate weight ratios:

| Component | Trade Name | Wt. % |
|---|---|---|
| Oligomer | InChemRez UV-91-TP20 | 41.4 |
| Monomer | TRPGDA | 45.6 |
| Photoinitiator/Photosensitizer | Acetocure 73 | 2.4 |
| Photoinitiator/Photosensitizer | Irgacure ® 184 | 3.6 |
| Photoinitiator/Photosensitizer | PI-718 | 0.6 |
| Extender Pigment | Aerosil ® | 0.6 |
| Extender Pigment | Syloid ® | 1.8 |
| Extender Pigment | Pioneer 4319 | 3.2 |
| Primary Pigment | Penn Color | 0.7 |

The above first and second exemplary formulations for a UV-curable coating for raw building materials are exemplary only, and one skilled in the art would recognize suitable substitutes according to stated functionality and chemical compatibility.

Compositions prepared according to the previous formulations have been found to inhibit mold growth. In addition, paint, regardless of composition, may inhibit fungus growth to one degree or another, and may be incorporated into the coating composition consistent with an aspect of the invention. To further inhibit or prevent fungus (e.g., mold) growth, antifungal agents or biocides may be added to the coating formulation. Non-exhaustive examples of commercially-available biocides include Acticide® 45, a 45% solution of octyl isothiazolone (OIT) in glycol, Acticide® OTW, a 15% OIT dispersion in water, Acticide® C98, a finely milled chorothalonil powder, and Acticide® C40, a 40% dispersion of chlorothalonil in water, all available from Acti-Chem Specialties, Inc. of Trumbull, Conn. These biocides were tested in various combinations, both together and separately, according to BS 3900 Part G6. Initial test periods were run for six months on uncoated lumber representative of the current industry standard and eighteen other formula variations. The dried films were periodically inoculated with a mixed fungal spore suspension followed by incubation in a humid environment. Resultant fungal growth was assessed by both visual and microscopic examination. FIG. 6 shows the various combinations of biocides that were tested, and the resultant fungal growth associated with each combination. Each of the coated samples in FIG. 6 exhibit considerably lower degree of fungal growth (9%-59%), when compared to the sample left uncoated (84% fungal growth). It should be noted that among those test samples treated with biocide formulations, a significant portion of fungal growth occurred at or near cracks in the wood or in locations of incomplete or partial coverage. These particular biocides are exemplary only, and one skilled in the art would recognize suitable substitutes according to stated functionality and chemical compatibility.

The enumerated biocides may prevent or inhibit the growth of at least the following fungi: Altemaria altemata, Aspergillus niger, Aspergillus oryzae, Aureobasidium pullulans, Ceratocystis sp., Chaetomium globosum, Cladosporium cladosporoides, Cladosporium resinae, Cladosporium herbarum, Fusaruim sp., Gliocladium virens, Lentunus tigrinus, Penicillium funiculosum, Penicilluim glaucum, Penicillium ochrochloron, Phoma sp., Rhizopus stolonifer, Scierophoma pithyophilia, Streptomyces sp., Trichoderma viridae, Paecilomyces variotii, and Ulocladium atrum. Biocides may also effective in preventing or inhibiting the growth of at least the following yeasts: Candida albicans, Rhodotorula rubra, Saccharomyces cerevisiae, and Sporobolomyces roseus.

In accordance with an additional aspect of the invention, the coating may be applied to raw building materials to mask cosmetic irregularities such as stains, discolorations, knots, irregular grains, or other characteristics that may be deemed to be aesthetically unappealing. Such cosmetic irregularities may have little or no substantial effect on the strength; durability; or any other functional characteristic of RBM 100. However, these cosmetic irregularities may adversely affect the price that consumers of RBM 100 are willing to pay. Thus, raw building material bearing these cosmetic irregularities may typically be offered for sale at a lower price. By masking these cosmetic irregularities with coating, RBM 100s may be offered for sale at a price the same or greater than if otherwise sold without such masking. To this end, pigments may be added to the composition that, when dry, exhibits a resultant opacity to substantially mask the cosmetic irregularities.

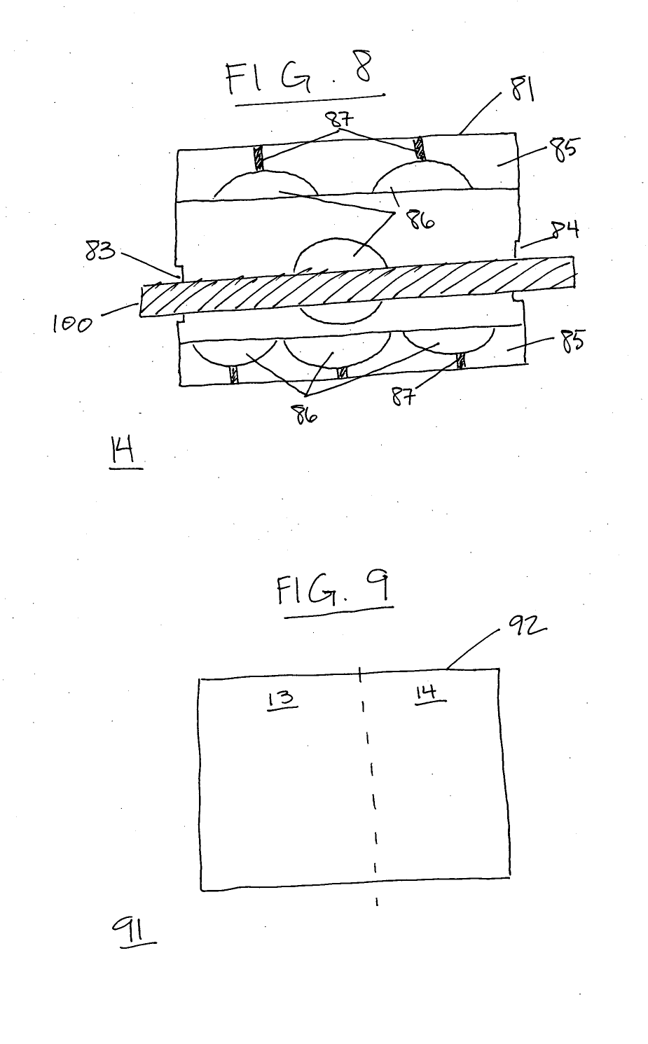

It is common practice in the raw building material industry, particularly the lumber industry, to stamp raw building materials with a grade. For lumber products, this grade stamp 705 may indicate, as shown in FIG. 7, for example, the point of origin or mill of production 710 of the lumber, wood species 720, moisture content 750, lumber grade 730 based on knot content, and/or a certification 740. For composite products, such as plywood, the grade stamp may indicate the exposure to which the product is best suited. In one embodiment of the invention, the opacity of the coating, once dry, is such that the cosmetic irregularities are masked, but the coating is sufficiently translucent so that the grade stamp 705 can be identified and read.

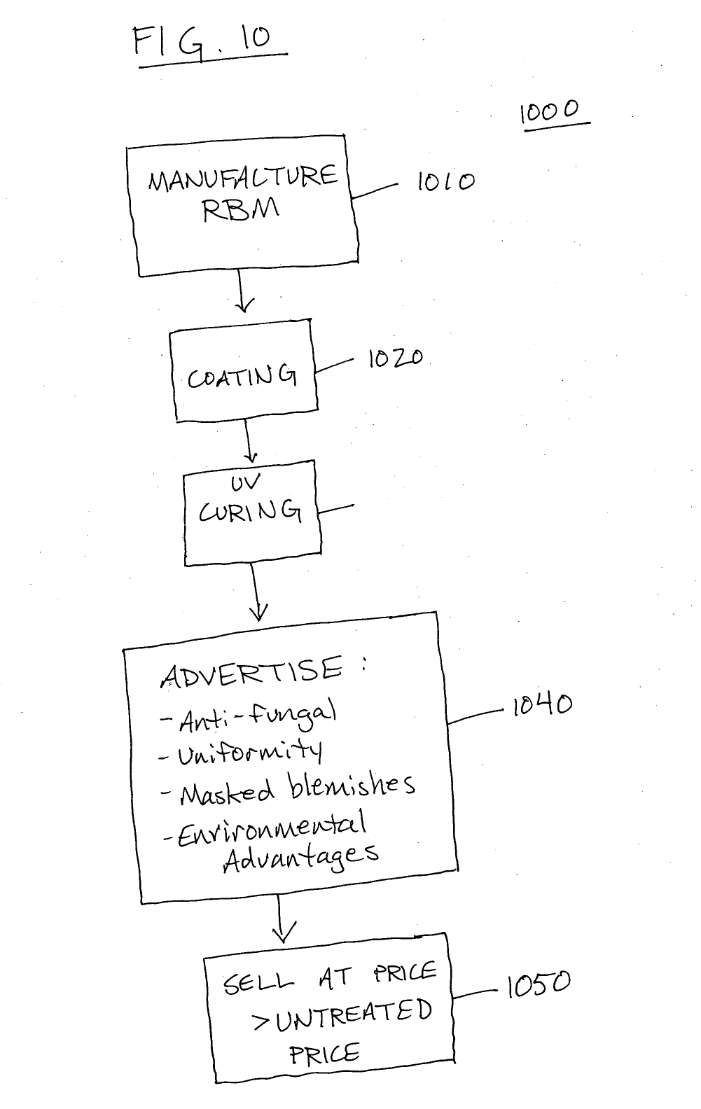

Turning to FIG. 8, an exemplary drying station 14 is shown in greater detail. Drying station 14 may comprise a structure 81 through which conveyor system 12 advances RBM 100. The structure 81 may be substantially enclosed, such as a chamber 82. The chamber 82 may include at least a first opening 83 and second opening 84. RBM 100 may enter the chamber through first opening 83 and exit chamber 82 through second opening 84 after the coating is dried. The structure 81 may further comprise equipment 85 to cure the coating by irradiation. As used herein, irradiation may include, for example, exposure to ultraviolet radiation (UV) or to electron beam emission (EB). UV lamps or other radiation sources for irradiating the coating applied to RBM 100 as RBM 100 is advanced through drying chamber 82 may be mounted on the interior of chamber 82, and are configured to expose RBM 100 to irradiation. The RBM 100 may be irradiated to an extent that the coating is substantially dry substantially instantaneously after exposure to irradiation. “Substantially instantaneously”, as used herein, includes, for example, within about 10 seconds of exposure to irradiation. Alternatively, the coating may be substantially dry within about two seconds, or within about 2-10 seconds after exposure to the radiation. The RBM may be considered “dry” or “substantially dry” when, for example, it is dry to the touch.

In a preferred embodiment, RBM 100 is exposed to UV radiation. UV radiation produced by gallium or mercury lamps 86, for example, substantially instantaneously polymerizes the coating. Drying station 14 may be a chamber 82 designed to fully enclose RBM 100 and UV lamps 86, thus allowing for substantially simultaneous curing of each surface of RBM 100. The freshly coated RBM 100 may be fed into drying station 14, passing over bottom UV lamps 86, located beneath RBM 100 to cure the underside of RBM 100. RBM 100 may pass under multiple lamps 86 located above and beside RBM 100 to cure the remaining surfaces. UV lamps 86 may be removeably mounted on flexible supports 87 to easily focus UV light onto RBM 100 and to optimize exposure. UV lamps 86 may be accessible from the exterior of chamber 82 for easy adjustment and maintenance. In a further preferred embodiment, drying station 14 may be equipped with seven 12-inch focused arc lamps 86 with adjustable output from about 125 to 400 wpi, for example. Three of these lamps 86 may be distributed beneath the coated RBM 100 as it is advanced through the coating station, while the remaining four may be distributed above and to the side of the coated RBM 100.

The drying station 14 of the preferred embodiment may be configured to substantially dry the coated RBM 100 (with an exemplary cross-sectional dimension up to about 12 inches by about 2.25 inches) at a rate of up to about 350 feet per minute. The coating station 14 may be modified to accommodate raw building materials of various cross-sections. Further, the number and location of UV lamps 86, as well as the length of the coating station 14, may also be modified to achieve faster production speeds. For example, production speeds of up to about 500-600 feet per minute may be achieved by utilizing a longer drying station or by modifying the UV or EB irradiation. Thus, the drying station 14 may be configured to dry at rates of less than 350 feet per minute up to 500-600 feet per minute or more. The UV Finish Line is a commercially-available UV-curing system that may be used with an embodiment of the invention. It is manufactured by Delle Vedove of Charlotte, N.C.

Consistent with a further aspect of the present invention, coating station 13 and drying station 14 may be one and the same, as depicted, for example, in FIG. 9. In this embodiment, a single structure 91 may carry both the coating systems and the drying systems, and may comprise a single chamber 92. The single chamber 92 may be further divided into at least two sub-chambers 13 and 14. The coating may be applied to the raw building material in the first sub-chamber 13, while the coated building material is substantially dried in the second sub-chamber 14.

In accordance with an additional aspect of the present invention, a method of inhibiting fungal growth on raw building materials may further include conveying, with conveyor system 12, coated RBM 100 away from drying station 14. This conveyor system 12 may be substantially similar to any of those discussed above, and may be an integral part of the other conveying system.

In another aspect of the invention, at least one of coating station 13 and drying station 14 may move relative to a volume of RBM 100 in order to advance RBM 100 through coating station 13 or drying station 14. In this embodiment, a volume of RBM 100 may be arranged on a static structure or frame. Once so arranged, coating station 13 or drying station 14 may be advanced over RBM 100.

A method of selling and/or marketing raw lumber and raw building materials that have been pre-coated with an antifungal coating consistent with the present invention will next be described with reference to FIG. 10. FIG. 10 illustrates a flow chart 1000 representing an exemplary method of adding sales value to a raw building material in accordance with a further aspect of the present invention. The method includes steps of manufacturing RBM (step 1010) and coating the RBM (step 1020). In step 1030, the RBM is UV cured and available for sale to a customer The RBM may be advertised as possessing antifungal properties, uniformity, masked blemishes, and/or environmental beneficiality (step 1040) to develop sales at prices greater than otherwise untreated RBM (step 1050). Thus, the coating process (step 1020) is inserted into the supply chain, without interference to the distribution of the RBM. Alternatively, the method of FIG. 10 may omit step 1040.

Further consistent with an aspect of the present invention, the coating process (1020) may include substantially covering a lot or a plurality of pieces of RBM with coating (as described above). The lot may then be marketed at a price greater than that associated with untreated or uncoated RBM.

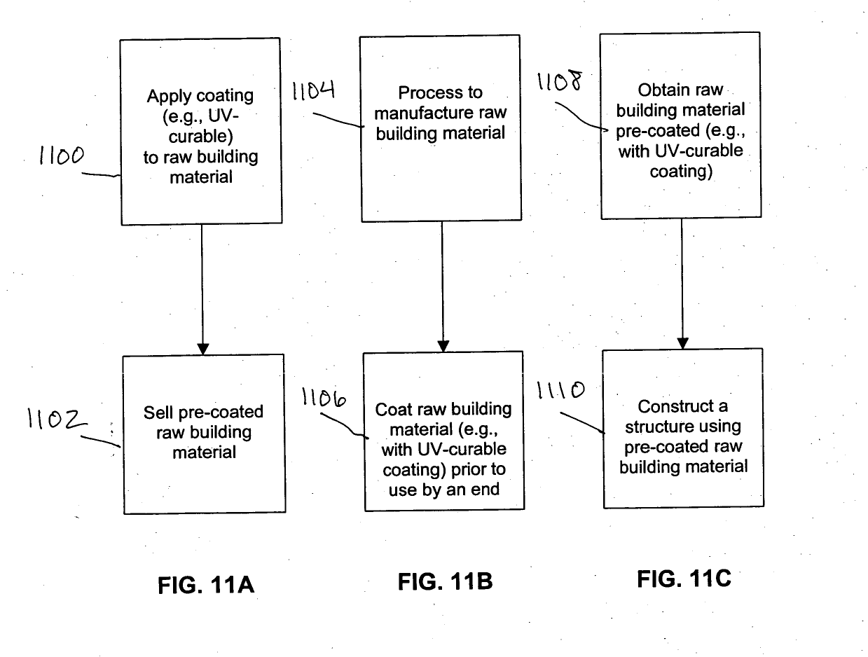

A further method of marketing and/or selling raw building materials that have been pre-coated with a UV-curable coating consistent with the present invention will be described with reference to FIGS. 11A-11C. The present invention may encompass application of an antifungal composition at a raw building material production facility (See, e.g., step 1104 in FIG. 11B), such as a lumber mill. The antifungal application (See, e.g., step 1106 in FIG. 11B) may be integrated into a production facility line, so that all or a portion of the facility's raw output receives an antifungal coating prior to shipment. Alternatively, the antifungal coating may be applied on site with a mobile coating machine. Preferably, the antifungal composition is a quick-drying composition, such as a UWEB curable composition like that previously described. This antifungal composition may applied by any conventional method, such as by vacuum coat, brush coat, spray coat, curtain coat, roller coat, or dip and squeegee. The vacuum coat method as described above is a preferred method. Further, applying the antifungal coating may require a curing step. As previously described, a UV curing method may be easily implemented.

In accordance with a further aspect of the invention, an anti-fungal coating consistent with the present invention may be applied to pre-fabricated building components, which may include roof-trusses. The coating may be cured by irradiation. The RBM used to manufacture the pre-fabricated building materials may be coated prior to fabrication. Alternately, the pre-fabricated building materials may be coated after fabrication.

In accordance with another aspect of the invention, sales value is added to RBM 100 treated in accordance to the invention as described above. The process of coating the raw building materials may be introduced in the supply chain between the location of manufacture and location of sale to an end user. Due to the above coating process, the raw building material will be more valuable to a customer. A customer may be defined by at least one of end users such as builders, raw building material retailers and wholesalers, and raw building material distributors. As previously discussed, the anti-fungal properties of the coating, with or without add added biocides, will lengthen the average life and thereby the value of raw building materials, particularly in geographic areas susceptible to mold infestations. Raw building materials coated to mask cosmetic irregularities may be sold at higher average cost per unit, because raw building materials bearing such cosmetic irregularities may not be discounted to a lower price. Further, the coating may be used to identify the producer or supplier of the raw building material and to provide a uniform appearance to the raw building materials. A customer that can more easily identify a brand may more easily develop brand-loyalty. Further, the raw building materials coated with substantially 100% solid, UV- or EB-cured coatings may carry a greater inherent value with environmentally-conscious customers. The method of adding sales value to the raw building material thus involves emphasizing these attributes to customers through marketing.

Marketing the pre-coated raw building materials may involve advertising by one or more of various means, including but not limited to: print media such as newspaper and magazine advertisements, and trade publications; broadcast media such as television and radio advertising, product placement, and event sponsorship; internet advertising; trade shows and industry conventions; product demonstrations by marketing staff for potential customers/consumers; in-store advertising; product packaging that emphasizes and particularly points out the coating. Marketing the pre-coated raw building materials may involve pointing out the particular treatment that has been applied to the materials, and presenting the particular advantages of the pre-coated building materials. For example, marketing materials could point out that the coating inhibits mold growth. Alternatively, or in addition, marketing to resellers might include pointing out that cosmetic blemishes on the raw building material's surface would be at least partially concealed by the coating. This characteristic would be of particular advantage to sellers and distributors of the building product, as less material would go un-sold (or require discounting) due to the cosmetic blemishes. Further, if a coating is applied by the vacuum coat method, the environmental advantages could be advanced through marketing materials. That is to say, because substantially 100% of the coating is eventually placed on the product and a negligible amount of coating is lost to the atmosphere, the process results in very little waste. Other advantages will be apparent, considering the type of coating applied.

As illustrated in FIG. 11A, for example, the present invention may further involve a method of selling and/or marketing raw lumber and raw building materials (step 1102) that have been pre-coated with an antifungal coating (step 1100). Selling the raw building materials pre-coated with an antifungal coating may include selling to, for example, end users of, as well as distributors, wholesalers, and retailers of raw and finished building materials. Marketing the raw building materials pre-coated with an antifungal coating may encompass advertising previously discussed. Marketing materials may include information relating the particular advantages of the antifungal coating, including but not limited to prevention and inhibition of fungal growth, potential costs of fungal infestation, relative low cost of pre-coated products, etc. Further, the present invention may involve a method of selling and/or marketing raw lumber and raw building materials that have been pre-coated with a UV- or EB-cured, antifungal coating. Because these types of coatings are nearly 100% solids, and no solvents are used, the negative environmental impact is reduced.

Yet another aspect of the present invention (See, e.g. FIG. 2C) may relate to a method of framing a building or structure (or at least a portion thereof) (step 1110) using raw building materials that are pre-coated with paint or another coating (step 1108). Particularly, the present invention may relate to a method of framing a building or structure using raw building materials that are pre-coated with a UV-curable, anti-fungal coating.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of applying a coating to raw building material, the method comprising the steps of:
supplying a volume of raw building material to a coating station, the raw building material comprising at least one of wood framing lumber, plywood sheeting, chipboard sheeting, sheet rock, particle board, soffet board, cementious board, wood trim lumber, facia board, composite board, and prefabricated roof trusses;
applying to the raw building material in the coating station a coating that cures substantially instantaneously when exposed to ultraviolet light; and
exposing coated raw building material to ultraviolet light.

2. The method of claim 1, wherein at least some of the raw building material is supplied to the coating station in lengths of at least about eight feet.

3. The method of claim 2, wherein the coating applied during the applying step includes at least one oligomer, at least one monomer, and at least one photoinitiator/photosensitizer for initiating free radical polymerization.

4. The method of claim 1, wherein the applying step occurs in less than about ten seconds.

5. The method of claim 1, wherein the applying step occurs in about two seconds.

6. The method of claim 1, wherein the applying step occurs in about 2-10 seconds.

7. Method of inhibiting fungal growth on raw building material, the method comprising:
supplying a volume of raw building material to a conveyor system;
conveying, with the conveyor system, the raw building material to a coating station;
applying in the coating station a coating that, when dry, inhibits fungal growth on the raw building material;
conveying, with the conveyor system, the raw building material to a drying station;
irradiating the raw building material, in the drying station, to thereby dry the raw building material substantially instantaneously; and
conveying with the conveyor system, raw building material away from the drying station.

8. The method of claim 7, wherein the raw building material is framing lumber.

9. The method of claim 7, wherein the raw building material comprises at least one of wood framing lumber, plywood sheeting, chipboard sheeting, sheet rock, particle board, soffet board, cementious board, wood trim lumber, facia board, composite board, and prefabricated roof trusses.

10. The method of claim 8, wherein the conveying system is configured to convey raw building material in lengths of about eight feet.

11. The method of claim 7, wherein the conveying system includes multiple conveyors.

12. The method of claim 7, wherein the conveying system includes a single conveyor.

13. The method of claim 7, wherein during at least one of the conveying steps, the raw building material is conveyed to at least one of the coating and drying stations by moving at least one of the coating and drying stations relative to the raw building material.

14. The method of claim 7, wherein the coating station and the drying station are one and the same.

15. The method of claim 7, wherein at least one of the coating station and the drying station is a chamber through which the conveyor moves raw building material.

16. The method of claim 7, wherein the coating is formulated to be cured with ultraviolet light, and wherein said irradiating step includes irradiating said raw building material with ultraviolet light.

17. The method of claim 7, wherein the coating is formulated to be cured with an electron beam, and wherein said irradiating step includes irradiating said raw building material with at least an electron beam.

18. The method of claim 7, wherein the coating applied during the step of coating includes at least one oligomer, at least one monomer, and at least one photoinitiator/photosensitizer for initiating free radical polymerization.

19. The method of claim 7 wherein moved by conveyor at a rate of at least about 50 feet per minute.

20. The method of claim 7, wherein during the step of irradiating, the coated raw building material dries within about ten seconds.

21. The method of claim 7, wherein during the step of irradiating, the coated raw building material dries within about two seconds.

22. The method of claim 7, wherein during the step of irradiating, the coated raw building material dries in about 2-10 seconds.

23. The method of claim 7, wherein the drying station is configured to substantially dry the coated raw building materials at a rate of at least about 50 feet per minute.

24. The method of claim 7, wherein the drying station is configured to substantially dry the coated raw building materials at a rate of about 50-100 feet per minute.

25. The method of claim 7, wherein the drying station is configured to substantially dry the coated raw building materials at a rate of about 100-300 feet per minute.

26. The method of claim 7, wherein the drying station is configured to substantially dry the coated raw building materials at a rate of about 300-600 feet per minute.

27. Method of masking cosmetic irregularities in raw building material, comprising:
supplying a volume of raw building material to a conveyor system, wherein at least a portion of the volume of raw building material contains cosmetic irregularities;
conveying, with the conveyor system, the raw building material to a coating station;
applying in the coating station a coating, said coating including a pigment that is sufficiently opaque to mask the cosmetic irregularities;
conveying, with the conveyor system, the raw building material to a drying station;
substantially drying, in the drying station, the coated raw building material; and
conveying with the conveyor system, raw building material away from the drying station.

28. The method of claim 27, wherein the raw building material comprises at least one of wood framing lumber, plywood sheeting, chipboard sheeting, sheet rock, particle board, soffet board, cementious board, wood trim lumber, facia board, composite board, and prefabricated roof trusses.

29. The method of claim 27, wherein the conveyor system is configured to convey raw building in lengths of at least about eight feet.

30. The method of claim 27, wherein the pigment, when dry, is sufficiently translucent to permit a lumber grade stamp to be visible through the coating.

31. The method of claim 27, wherein the coating is substantially non-volatile.

32. The method of claim 27, wherein the coating is formulated to be cured by exposure to ultraviolet radiation.

33. The method of claim 27, wherein the coating provides a uniform appearance to the raw building material.

34. A method of adding sales value to raw building material, the method comprising:
introducing a coating process into a raw building material supply chain between a location of manufacture and a location of sale to an end user;
during the coating process, substantially covering a lot of raw building material with a coating, the lot being defined by a plurality of pieces of raw building material, and the coating being formulated to achieve at least one of the following functions: to mask cosmetic irregularities in the individual pieces in the lot; to provide a uniform appearance to the pieces in the lot; and to inhibit future fungal growth in the lot; and
offering the coated raw building material for sale at a price greater than a market price for uncoated raw building material.

35. The method of claim 34, wherein the raw building material comprises at least one of wood framing lumber, plywood sheeting, chipboard sheeting, sheet rock, particle board, soffet board, cementious board, wood trim lumber, facia board, composite board, and prefabricated roof trusses.

36. The method of claim 34, wherein the lot of raw building material contains pieces in lengths of at least about eight feet.

37. The method of claim 34, wherein introducing the coating process occurs at a location of manufacture.

38. The method of claim 34, wherein introducing the coating process occurs a location in the supply chain other than a location of manufacture.

39. The method of claim 34, wherein the coating is formulated for ultraviolet curing, and wherein during the coating process, the coating is at least partially dried using ultraviolet light.

40. The method of claim 34, wherein the coating, when dry, is sufficiently translucent to permit a lumber grade stamp to be viewed through the coating.

41. Raw building material having a coating substantially covering the surface of the raw building material, wherein the raw building material contains cosmetic irregularities;
said coating, when dry, is sufficiently opaque to substantially mask the cosmetic irregularities; and
said coating is dried by irradiating the coated raw building material to an extent sufficient to substantially dry the coating substantially instantaneously.

42. The raw building material of claim 41, wherein said coating is sufficiently translucent to permit a lumber grade stamp to be visible through the coating.

43. The raw building material of claim 41, wherein drying the coating substantially instantaneously occurs within about ten seconds.

44. The raw building material of claim 41, wherein drying the coating substantially instantaneously occurs within about two seconds.

45. The raw building material of claim 41, wherein drying the coating substantially instantaneously occurs in about 2-10 seconds.

46. The raw building material of claim 41, wherein said raw building material comprises at least one of wood framing lumber, plywood sheeting, chipboard sheeting, sheet rock, particle board, soffet board, cementious board, wood trim lumber, facia board, composite board, and prefabricated roof trusses.

47. The raw building material of claim 41, wherein said coating comprises at least one oligomer, at least one monomer, and at least one photoinitiator/photosensitizer for initiating free radical polymerization.
